(19) United States
(12) Patent Application Publication
(10) Pub. No.: US 2025/0205817 A1
(43) Pub. Date: Jun. 26, 2025

(54) Laser Welding Device

(71) Applicant: LG Energy Solution, Ltd., Seoul (KR)

(72) Inventor: Seok Hong Ham, Daejeon (KR)

(73) Assignee: LG Energy Solution, Ltd., Seoul (KR)

(21) Appl. No.: 18/702,061

(22) PCT Filed: Oct. 20, 2022
(86) PCT No.: PCT/KR2022/016043

§ 371 Date: Feb. 28, 2025

(30) Foreign Application Priority Data
Oct. 20, 2021 (KR) 10-2021-0140231

(51) Int. Cl. B23K 26/21

(52) U.S. Cl. CPC B23K 26/21

(57) ABSTRACT

The present invention provides a laser welding device, which irradiates laser to perform welding so that an electrode lead and an electrode tab sequentially pass through an opening hole of a base plate and an opening hole of an upper mask when the electrode lead and the electrode tab are seated on a lower mask in a state in which a laser irradiator, the base plate, and the upper mask are coupled to each other, the laser welding device including: the base plate provided with a coupling tool that protrudes from one surface thereof; and the upper mask provided with a coupling hole through which the coupling tool enters and coupled to the base plate by coupling the coupling tool to the coupling hole, wherein the coupling tool comprises a cylinder which has a hollow shape therein in a longitudinal direction and in which an air hole is punched, a piston which is capable of being slid inside the cylinder in a state of being coupled to a spring and has a section of which a diameter is reduced toward one side thereof, and a ball coupled to the cylinder, and when the coupling hole enters the inside of the coupling hole, the ball enters a groove formed in an inner circumferential surface of the coupling hole by the piston so as to be prevented from being separated, wherein, when air is injected into the air hole, the piston is slid to separate the ball from the groove.

### TECHNICAL FIELD

### Cross-Reference to Related Application

The present application claims the benefit of the priority of Korean Patent Application No. 10-2021-0140231, filed on Oct. 20, 2021, which is hereby incorporated by reference in its entirety.

### TECHNICAL FIELD

The present invention relates to a laser welding device that welds an electrode tab extending from an electrode assembly to an electrode lead having one end extending outside a pouch and the other end disposed inside the pouch when manufacturing a secondary battery, and more particularly, to a laser welding device, in which an upper mask is improved in convenience of replacement.

### BACKGROUND ART

Lithium secondary batteries that are chargeable/dischargeable and lightweight and have high output densities are being widely used as energy sources for various devices.

In addition, lithium secondary batteries have

attracted considerable attention as power sources for hybrid electric vehicles (HEVs), plug-in hybrid electric vehicles (PHEVs), battery electric vehicles (BEVs), and electric vehicles (EVs), which have been developed to solve limitations, such as air pollution and green-house gases, caused by existing internal-combustion engine vehicles that use fossil fuels, such as, gasoline and diesel vehicles.

In general, such a secondary battery has a structure comprising an electrode assembly having a structure in which electrodes (a negative electrode and a positive electrode) and a separator are alternately laminated, an electrolyte allowing ions to move to the electrodes, and a case in which the electrode assembly and the electrolyte are accommodated.

Also, the may lithium secondary battery be manufactured in various shapes. Representatively, the lithium secondary battery may be manufactured in a cylinder type, a prismatic type, or a pouch type.

Among them, the pouch-type secondary battery is manufactured by sealing an opened portion of a pouch when an electrode assembly, which charges and discharges electric energy, and an electrolyte are embedded in the pouch.

The electrode assembly is provided by alternately stacking negative electrodes, positive electrodes, and separators and is manufactured so that a negative electrode tab protruding from the negative electrodes and a positive electrode tab protruding from the positive electrodes protrude from the same side or respectively protrude opposite sides. In addition, each of the electrode tabs (positive electrode tab and negative electrode tab) is mounted in the pouch in a state of being welded to electrode leads (positive electrode lead and negative electrode lead).

Thus, in a state in which the electrode lead and the electrode tab are welded to each other, the electrode lead has one side connected to the electrode tab within the pouch and the other side protruding to the outside the pouch so as to be electrically connected to an external device.

The electrode lead and the electrode tab are welded through a laser welding device 1 as illustrated in FIG. 1a.

The laser welding device 1 includes a lower mask 5 on which an electrode lead L and an electrode tab T are seated, a laser irradiator 4 irradiating laser to a point at which the electrode lead L and the electrode tab T, which are seated on the lower mask 5, are stacked, a base plate 2 coupled to a lower portion of the laser irradiator 4, and an upper mask detachably coupled to the base plate 2.

In addition, the laser irradiated from the laser irradiator 4 irradiates the laser through an opening hole 2c of the base plate 2 and an opening hole 3d of the upper mask 3 so that the welding is performed. That is, an upper end 3e of the opening hole 3d of the upper mask 3 communicates with the opening hole 2c of the base plate 2. In addition, the upper mask 3 has a shape that is gradually narrowed toward a lower end thereof, and a lower end 3f of the opening hole 3d is disposed above a welding point W of the electrode lead L and the electrode tab T.

In addition, during laser welding, an inert gas is injected to prevent scattering of spatter and improve welding quality.

Referring to FIG. 1b, which illustrates a shape (below) of a side surface of an upper mask 3 according to the related art and a state (below) in which the base plate 2 is disposed upside down, and FIG. 1c, which illustrates a cross-sectional view of a state in which the upper mask 3 according to the related art is coupled to the base plate 2, a locking part 3a protrudes from the upper mask 3 according to the related art, and a catcher 2a, in which the locking part 3a is inserted and fixed, is provided on the base plate 2. That is, in the structure according to the related art, the base plate 2 and the upper mask 3 are attached to and detached from each other through coupling and separation of the locking part 3a and the catcher 2a. Here, the coupling and separation of the locking part 3a and the catcher 2a are performed manually by a worker using a dedicated tool.

In addition, the upper mask 3 may be provided with a hollow cone-shaped portion that is pointed toward an electrode tab T and an electrode lead T, and opening holes 3d, 3e, and 3f provided inside the upper mask 3 may also have a shape that is pointed toward the end 3f of the opening holes 3d, 3e, and 3f. In addition, the upper mask 3 is formed with gas passages 3b and 3c therein so that an inert gas is injected to both sides and supplied to the end 3f of the opening holes 3d, 3e, and 3f. Here, one 3c of the gas passages 3b and 3c receives the inert gas through the base plate 2 and the opened hole 2b (right side in FIG. 1c), and the other one 3b is directly connected to an external tube or hose H to receive the inert gas (left side in FIG. 1c). Then, the inert gas collected toward the end 3f of the opening hole is contact with a welded portion W and then is discharged through the opening hole 3e of the upper mask 3 and the opening hole 2c of the base plate 2.

During the welding, melting occurs at the welded point, and spatter S is scattered in the form of small particles. Since the spatter S is attached to a surface of the upper mask 2, as the welding progresses, there is a problem that the spatter is accumulated on the surface of the upper mask 3 to cover the gas passages 3b and 3c, and as a result, it needs to be replaced periodically.

However, in the structure according to the related art, the external tube or hose for injecting the inert gas may be separately separated, and then, the locking part 3a and the catcher 3b are separated from each other to perform detachment of the upper mask 3, but there is a difference in replacement time according to the skill level of the worker, and there is a problem that a welding process is delayed during the replacement time. Although a magnet is attached to the locking part 3a to easily perform the coupling of the locking part 3a and the catcher 3b by magnetic force, the magnetic force may rather be an obstacle during the separation operation.

Therefore, in the present invention, there is a need to provide a new coupling structure in which the upper mask 3 and the base plate 2 are easily coupled to and separated from each other.

### DISCLOSURE OF THE INVENTION

### Technical Problem

Therefore, a main object of the present invention is to provide a laser welding device capable of easily coupling and separating an upper mask to/from a base plate.

### Technical Solution

The present invention for achieving the above object provides a laser welding device, which irradiates laser to perform welding so that an electrode lead and an electrode tab sequentially pass through an opening hole of a base plate and an opening hole of an upper mask when the electrode lead and the electrode tab are seated on a lower mask in a state in which a laser irradiator, the base plate, and the upper mask are coupled to each other, the laser welding device including: the base plate provided with a coupling tool that protrudes from one surface thereof; and the upper mask provided with a coupling hole through which the coupling tool enters and coupled to the base plate by coupling the coupling tool to the coupling hole, wherein the coupling tool comprises a cylinder which has a hollow shape therein in a longitudinal direction and in which an air hole is punched, a piston which is capable of being slid inside the cylinder in a state of being coupled to a spring and has a section of which a diameter is reduced toward one side thereof, and a ball coupled to the cylinder, and when the coupling hole enters the inside of the coupling hole, the ball enters a groove formed in an inner circumferential surface of the coupling hole by the piston so as to be prevented from being separated, wherein, when air is injected into the air hole, the piston is slid to separate the ball from the groove.

A flange of which a diameter is expanded may be formed on an end of a side of the piston, at which a diameter is relatively expanded, and the spring may be disposed at one side of the piston, and the air hole may be formed in the cylinder at the other side of the piston with respect to the flange.

A sleeve may be coupled to the upper mask, and the coupling hole and the groove may be formed in the sleeve so that the coupling tool is coupled to the sleeve. That is, the coupling hole and the groove may be provided in the upper mask itself, or the sleeve may be separately mounted.

At least two or more coupling tools may be provided on the base plate, and a plurality of coupling holes corresponding to the number of coupling tools may be formed in the upper mask.

A plurality of balls may be coupled along a circumference of the cylinder.

The upper mask may include a gas passage through which an inert gas moves, and an injection hole through which the inert gas is injected into the gas passage may be formed in the base plate, and when the upper mask is coupled to the base plate, the gas passage and the injection hole may communicate with each other.

The upper mask may include a hollow cone shaped portion that is pointed to be gathered at an end thereof so that the opening hole through which the laser passes communicates at the end that is pointed to be gathered, and the gas passage may be formed to be continued to the opening hole.

The gas passage may be formed to be continued from the inside of a shape surface that forms a shape of the upper mask.

The inert gas injected through the gas passage may be discharged through the opening hole of the base plate and the opening hole of the upper mask.

The inert gas may include nitrogen (N₂).

### Advantageous Effects

In the present invention having the configuration as described above, the detachment of the base plate and the upper mask may be performed by the coupling tool, and since the coupling tool is coupled or separated according to whether the air is injected, the coupling tool may be quickly detachable. Thus, even the unskilled person may more quickly and easily attach and detach the upper mask.

The coupling hole into which the coupling tool enters and the groove into which the ball of the coupling tool enters may be integrally formed on the upper mask. Alternatively, since the separate sleeve is provided, the sleeve may be added so that the upper mask according to the related art is used as it is.

Since the upper mask has the structure in which the inert gas is supplied through the injection hole of the base plate, there may be unnecessary to couple and separate the separate hose for injecting the inert gas or the external tube, thereby more quickly replace the upper mask.

### BRIEF DESCRIPTION OF THE DRAWINGS

FIG. 1a is a schematic perspective view illustrating an overall shape of a laser welding device.

FIG. 1b is a side view illustrating a shape (above) in which an upper mask according to the related art is separated from the laser welding device of FIG. 1a and a state (below) in which a base plate according to the related art is disposed upside down so that a bottom surface that is in contact with the upper mask is seen.

FIG. 1c is a cross-sectional view illustrating a state in which the upper mask and the base plate are coupled to each other according to the related art.

FIG. 2 is a view illustrating a shape (above) in which an upper mask according to the present invention is separated and a state (below) in which a base plate according to the present invention is disposed upside down so that a bottom surface that is in contact with the upper mask is shown.

FIG. 3 is a cross-sectional view illustrating a portion having a hollow cone shape when the upper mask and the base plate are coupled to each other according to the present invention.

FIG. 4 is a longitudinal cross-sectional view illustrating a coupling tool according to the present invention.

FIG. 5 is a view illustrating a state (i) in which the coupling tool is locked to a sleeve and a state (ii) in which the coupling tool is unlocked from the sleeve.

### MODE FOR CARRYING OUT THE INVENTION

Hereinafter, preferred embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein.

In order to clearly describe the present invention, parts irrelevant to the description are omitted, and the same reference numerals are assigned to the same or similar components throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

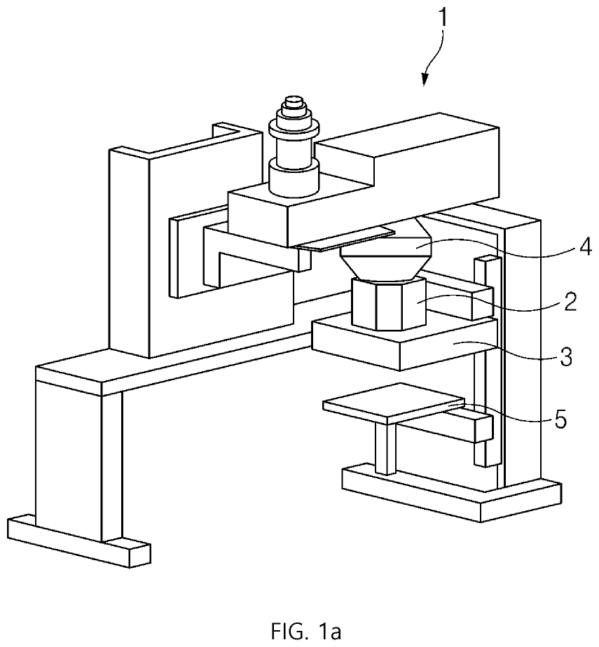

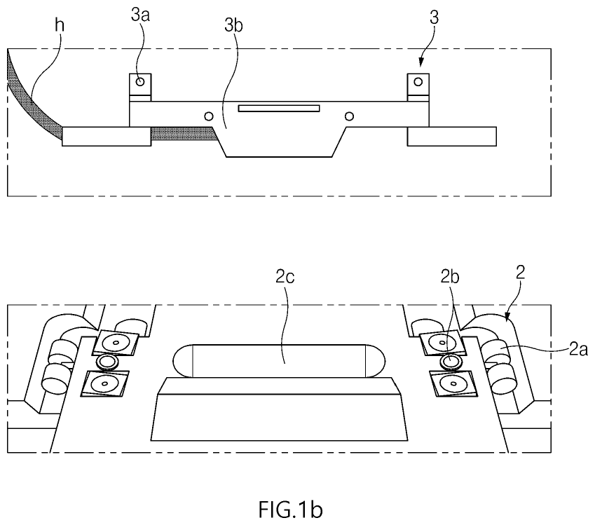

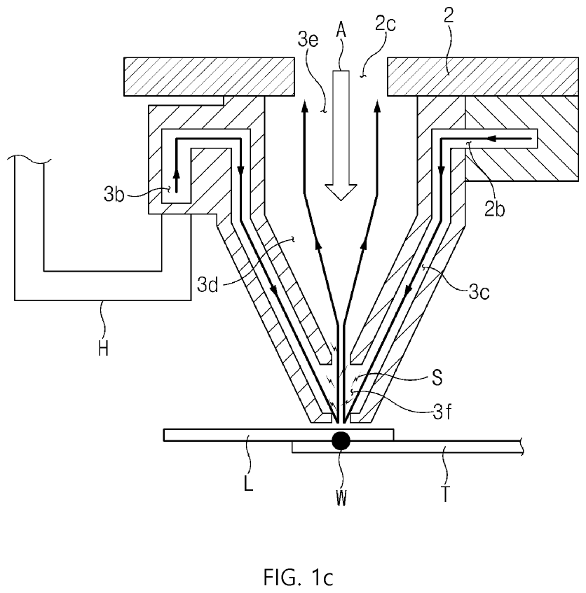

The present invention relates to a laser welding device in which welding of an electrode tab and an electrode lead is performed by irradiating laser from a laser irradiator so that the electrode lead and the electrode tab sequentially pass through an opening hole of a base plate and an opening hole of an upper mask when the electrode lead and the electrode tab are seated on a lower mask in a state in which the laser irradiator, the base plate, and the upper mask are coupled to each other from top to bottom as illustrated in FIG. 1, and hereinafter, an embodiment of the present invention will be described in more detail with reference to the accompanying drawings.

That is, like the above-described structure according to the related art, a laser welding device according to the present invention includes a lower mask, a laser irradiator, a base plate 20, and an upper mask 30.

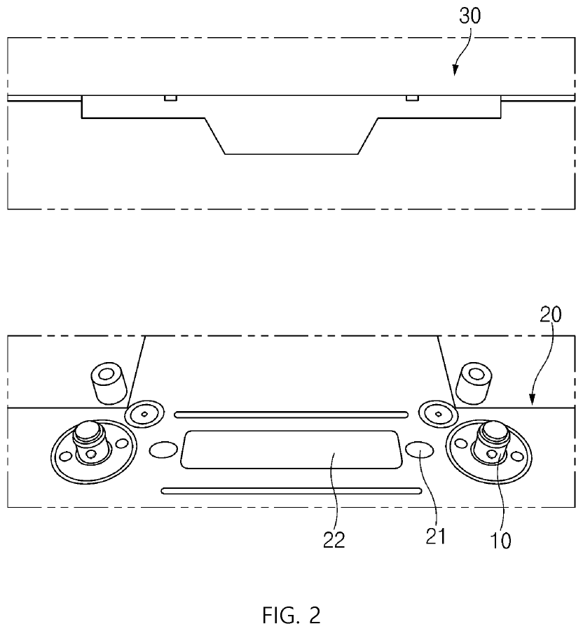

FIG. 2 is a view illustrating a shape (above) in which the upper mask 30 according to the present invention is separated and a state (below) in which the base plate 20 according to the present invention is disposed upside down so that a bottom surface that is in contact with the upper mask 30 is shown.

Instead of the locking part and the catcher according to the related art, in the structure according to the present invention, the upper mask 30 is provided with a coupling hole (the coupling hole is integrally formed in the upper mask itself, or a sleeve in which the coupling hole is formed is coupled), and a coupling tool 10 capable of being fixed to the coupling hole is provided on the base plate 20.

That is, the base plate 20 has a structure, in which the coupling tool 10 is mounted on one surface (i.e., a bottom surface when disposed as illustrated in FIG. 1a), to which the upper mask 30 is coupled, to protrude from the surface, and the coupling hole is provided in the upper mask 30.

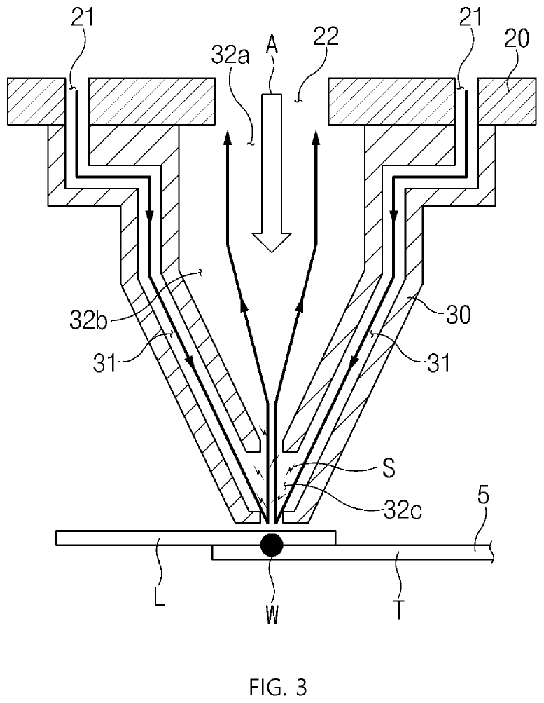

FIG. 3 is a cross-sectional view illustrating a portion having a hollow cone shape when the upper mask 30 and the base plate 20 are coupled to each other according to the present invention. For reference, a portion at which the coupling tool 10 is coupled to the coupling hole is omitted in FIG. 3 as a point disposed outside in FIG. 3.

As illustrated in the drawings, the upper mask 30 is provided with a portion that is formed in the form of a hollow cone shape that is pointed to be gathered at an end thereof, and thus, opening holes 32a, 32b, and 32c into which the laser is irradiated may be formed to communicate with each other at the end at which the opening holes 32a, 32b, and 32c are pointed to be gathered toward a point W to be welded, and a gas passage 31 is also connected to a lower end 32c of the opening holes 32a, 32b, and 32c.

The gas passage 31 is a passage, through which an inert gas moves, and is formed to be continued from the inside of the shape surface forming the shape of the upper mask 30 so that the inert gas is supplied to the point W at which the welding is performed. The shape surface means a portion constituting an outer appearance and having a thickness to form the cone shape in the upper mask 30.

In the upper mask 30 provided in the present invention, unlike the structure according to the related art, the inert gas may not be directly injected through an external tube or hose H, but may be injected through an injection hole 21 formed in the base plate 20.

That is, the external tube or hose H according to the related art is connected to one side of the injection hole 21 formed in the base plate 20, and when the upper mask 30 is coupled to the base plate, the other side of the external tube or hose H communicates with the gas passage 31 of the upper mask 30.

And, as illustrated in FIG. 3, while the electrode tab T and the electrode lead L are laser-welded to each other, the inert gas injected through the gas passage 31 acts to stabilize the welding at the point W at which the welding is performed and is continuously supplied and then discharged through the opening hole 22 of the base plate 20 and the opening holes 32a, 32b, and 32c of the upper mask 30.

That is, the inert gas injected into the gas passage 31 is discharged through the opening hole 22 of the base plate via a lower end 32c, an intermediate end 32b, and an upper end 32a of the opening hole of the upper mask 30. Here, nitrogen (N₂) may be provided as the inert gas.

In addition, the coupling tool 10 provided in the present invention are disposed outside each of both sides of the injection hole 21 of the base plate 20, as illustrated in FIG. 2.

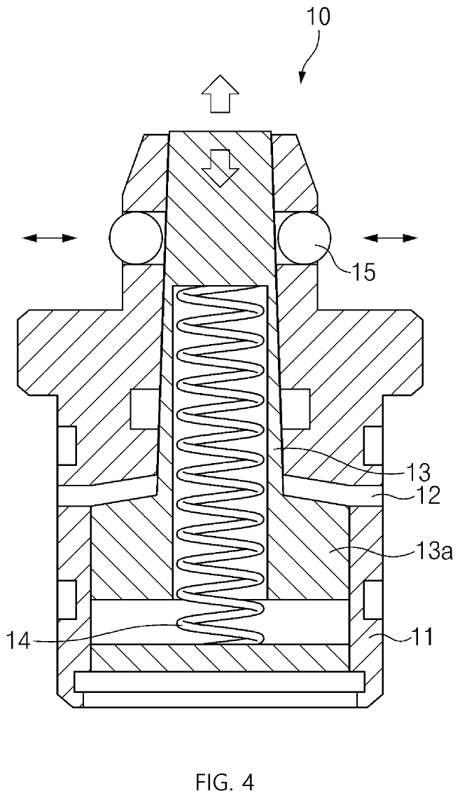

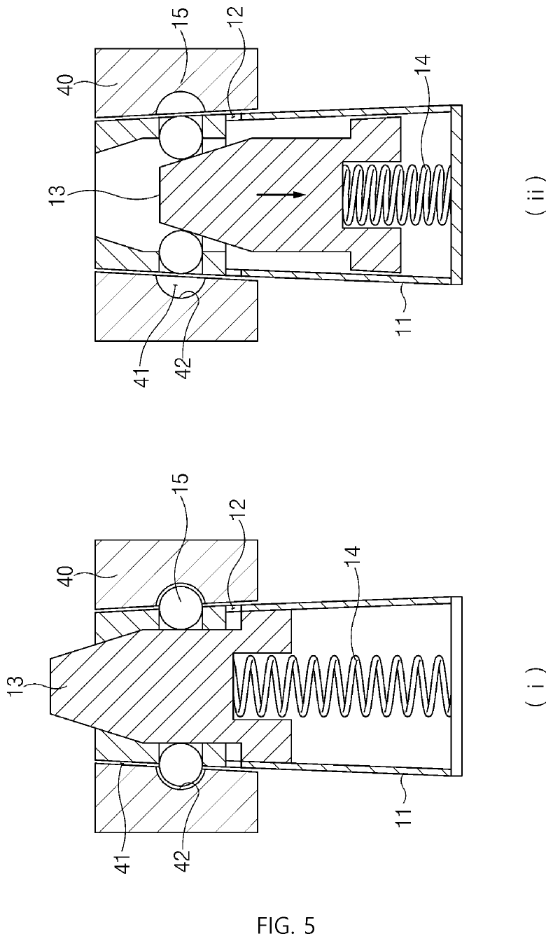

FIG. 4 is a longitudinal cross-sectional view illustrating the coupling tool 10 according to the present invention, and FIG. 5 is a view illustrating a state (i) in which the coupling tool 10 is locked to a sleeve 40 and a state (ii) in which the coupling tool 10 is unlocked from the sleeve 40.

The coupling tool 10 may be configured so that a piston 13 is coupled inside a cylinder 11, and a ball 15 protrudes from a surface of the cylinder 11 so as to be locked or unlocked according to a sliding position of the piston 13.

Referring to the drawings, the cylinder 11 has a hollow shape in a longitudinal direction, and an air hole 12 is punched at a predetermined height. The air hole 12 allows the inside and outside of the cylinder 11 to communicate with each other.

The piston 13 is slidably mounted inside the cylinder 11 in a state in which one end of the piston 13 is pressed by elastic force. The piston 13 has a shape of which a diameter decreases toward one side, or a section of which a diameter decreases toward one side thereof is formed on at least a portion of the piston 13.

In addition, at least one or more balls 15 are coupled along a circumference of the cylinder 11, preferably a plurality of balls 15 are coupled at regular intervals along the circumference of the cylinder 11. Although not clearly shown in the drawing, the ball 15 is disposed to be coupled and restricted by an elastic body (not shown) so that a portion of the ball 15 is embedded into the cylinder 11, and the ball 15 is behaved to protrude from the surface of the cylinder 11 when the ball is in contact with a portion at which the diameter of the piston 14 is expanded according to the sliding of the piston 13, and to be embedded in an original state when the ball 15 is in contact with a portion at which the diameter of the piston 13 is contracted.

Here, a flange 13a of which a diameter is expanded is disposed on an end (or the intermediate end) of a side of the piston13, at which a diameter is relatively expanded. In addition, a spring 14 is disposed at one side (a lower side in FIG. 4) of the piston 13, and an air hole 12 is formed in the cylinder 11 at the other side (an upper side in FIG. 4) of the piston 13.

The piston 13 has a diameter that gradually increases downward in FIG. 4. Thus, when the piston 13 ascends by the elastic force of the spring 14, the ball 15 is pressed by the piston 13 to protrude outward from the surface of the cylinder 11.

In addition, when compressed air is supplied to the air hole 12, a pressure in a space (in detail, a space opposite to a space in which the spring is disposed when the space inside the cylinder is divided with respect to the flange) inside the cylinder 11 increases. Thus, the piston 13 overcomes the elastic force of the spring 14 to descend, and the ball 15 is restored to be embedded in the original state in the cylinder 11 as the pressure pressed by the piston 13 is released.

In addition, the coupling hole is provided in the upper mask 30 so that the coupling tools 10 enter according to positions at which the coupling tools 10 are disposed, and a groove is formed in an inner circumferential surface of the coupling hole to have a concave shape. The coupling hole and the groove may be integrally formed in the upper mask 30, but the sleeve 40 provided with the coupling hole 41 and the groove 42 may be provided in a shape coupled to the upper mask 30.

FIG. 5 is a view illustrating a state in which the coupling hole 41 and the groove 42 are provided in a ring-shaped sleeve 40 that is separately coupled to the upper mask 30, and the coupling tool 10 is coupled to the sleeve 40.

Referring to FIG. 5, as illustrated at a left side, when the coupling tool 10 enters the coupling hole 41, the ball 15 enters the groove 42 formed in an inner circumferential surface of the coupling hole 41 by the piston 13 so that the coupling tool 10 is restricted to the sleeve 40. Here, since the coupling tool 10 is coupled to the base plate 20 and the sleeve 40 is fixed to the upper mask 30, the base plate 20 and the upper mast 30 are coupled to each other. That is, the coupling tool 10 fixed to the base plate 20 may be fitted into the coupling hole 41, and thus, the base plate 20 and the upper mask 30 may be coupled to each other in a one-touch manner.

For reference, the piston 13 of FIG. 5 is illustrated as a structure having both the portion of the piston 13 having the constant diameter and the portion of the piston 13 having the variable diameter, but the shape of the piston 13 may vary according to a size of the ball 15 or an inner diameter of the coupling hole 41.

In addition, when the air (compressed air) is injected through the air hole 12, as illustrated at the right side of FIG. 5, the pressure in the space opposite to the spring 14 increases, and thus, the piston 13 is slid in a direction in which the piston 13 is retreated (downward in FIG. 5). Here, since a point at which the diameter of the piston 13 is reduced faces the ball 15, the pressure applied to the ball 15 is released.

Therefore, the coupling tool 10 may be separated from the coupling hole 41, and thus, the base plate 20 and the upper mask 30 may be separated from each other.

In order to properly support a weight of the upper mask 30, it is preferable that the base plate 20 is provided with at least two or more coupling tools 10, and the upper mask 30 has a plurality of coupling tools 10, which correspond to the number of coupling tools 10. In addition, it is preferable to have a structure in which the plurality of balls 15 are disposed along the circumference of the cylinder 11 so that the coupling tool 10 is restricted more efficiently.

In the present invention having the configuration as described above, the detachment of the base plate 20 and the upper mask 30 may be performed by the coupling tool 10, and since the coupling tool 10 is coupled or separated according to whether the air is injected, the coupling tool 10 may be quickly detachable. Thus, even the unskilled person may more quickly and easily attach and detach the upper mask.

The coupling hole into which the coupling tool 10 enters and the groove into which the ball of the coupling tool enters may be integrally formed on the upper mask. Alternatively, since the separate sleeve 40 is provided, the sleeve 40 may be added so that the upper mask according to the related art is used as it is.

Since the upper mask 30 has the structure in which the inert gas is supplied through the injection hole of the base plate 20, there may be unnecessary to couple and separate the separate hose H for injecting the inert gas or the external tube, thereby more quickly replace the upper mask.

While the embodiments of the present invention have been described with reference to the specific embodiments, it will be apparent to those skilled in the art that various changes and modifications may be made without departing from the spirit and scope of the invention as defined in the following claims.

### DESCRIPTION OF THE SYMBOLS

10: Coupling tool
20: Base plate
30: Upper mask
40: Sleeve

1. A laser welding device, which irradiates laser to perform welding so that an electrode lead and an electrode tab sequentially pass through an opening hole of a base plate and an opening hole of an upper mask when the electrode lead and the electrode tab are seated on a lower mask in a state in which a laser irradiator, the base plate, and the upper mask are coupled to each other, the laser welding device comprising:
the base plate provided with a coupling tool that protrudes from one surface thereof; and
the upper mask provided with a coupling hole through which the coupling tool enters and coupled to the base plate by coupling the coupling tool to the coupling hole,
wherein the coupling tool comprises a cylinder which has a hollow shape therein in a longitudinal direction and in which an air hole is punched, a piston which is capable of being slid inside the cylinder in a state of being coupled to a spring and has a section of which a diameter is reduced toward one side thereof, and a ball coupled to the cylinder, and
when the coupling hole enters the inside of the coupling hole, the ball enters a groove formed in an inner circumferential surface of the coupling hole by the piston so as to be prevented from being separated, wherein, when air is injected into the air hole, the piston is slid to separate the ball from the groove.

2. The laser welding device of claim 1, wherein a flange of which a diameter is expanded is formed on an end of a side of the piston, at which a diameter is relatively expanded, and
the spring is disposed at one side of the piston, and the air hole is formed in the cylinder at the other side of the piston with respect to the flange.

3. The laser welding device of claim 2, wherein a sleeve is coupled to the upper mask, and the coupling hole and the groove are formed in the sleeve so that the coupling tool is coupled to the sleeve.

4. The laser welding device of claim 1, wherein at least two or more coupling tools are provided on the base plate, and a plurality of coupling holes corresponding to the number of coupling tools are formed in the upper mask.

5. The laser welding device of claim 1, wherein a plurality of balls are coupled along a circumference of the cylinder.

6. The laser welding device of claim 1, wherein the upper mask comprises a gas passage through which an inert gas moves, and an injection hole through which the inert gas is injected into the gas passage is formed in the base plate, and
when the upper mask is coupled to the base plate, the gas passage and the injection hole communicate with each other.

7. The laser welding device of claim 6, wherein the upper mask comprises a hollow cone shaped portion that is pointed to be gathered at an end thereof so that the opening hole through which the laser passes communicates at the end that is pointed to be gathered, and
the gas passage is formed to be continued to the opening hole.

8. The laser welding device of claim 7, wherein the gas passage is formed to be continued from the inside of a shape surface that forms a shape of the upper mask.

9. The laser welding device of claim 8, wherein the inert gas injected through the gas passage is discharged through the opening hole of the base plate and the opening hole of the upper mask.

10. The laser welding device of claim 6, wherein the inert gas comprises nitrogen.
